(19) United States
(12) Patent Application Publication
(10) Pub. No.: US 2015/0350120 A1
(43) Pub. Date: Dec. 3, 2015

(54) METHOD AND DEVICE FOR MANAGING INSTANT MESSAGE

(71) Applicant: XIAOMI INC., Beijing (CN)

(72) Inventor: Guoming LIU, Beijing (CN)

(73) Assignee: XIAOMI INC.

(21) Appl. No.: 14/605,252

(22) Filed: Jan. 26, 2015

Related U.S. Application Data
(63) Continuation of application No. PCT/CN2014/089208, filed on Oct. 22, 2014.

(30) Foreign Application Priority Data
May 27, 2014 (CN) 201410228013.4

(51) Int. Cl. H04L 12/58; H04L 29/08

(52) U.S. Cl. CPC H04L 51/04; H04L 67/141

(57) ABSTRACT

A method for a terminal to manage an instant message, includes: determining whether the instant message is a reply to an existing message when receiving or sending the instant message; if the instant message is not a reply to any existing message, creating a new session and adding the instant message as a root node into the new session; and if the instant message is a reply to an existing message, adding the instant message into a session to which the existing message belongs and setting the instant message as a child node of the existing message.

### CROSS-REFERENCE TO RELATED APPLICATIONS

The present application is a continuation of International Application No. PCT/CN2014/089208, filed Oct. 22, 2014, which is based upon and claims priority to Chinese Patent Application No. 201410228013.4, filed May 27, 2014, the entire contents of all of which are incorporated herein by reference.

### TECHNICAL FIELD

The present disclosure generally relates to the field of instant messaging and, more particularly, to a method and a device for managing an instant message.

### BACKGROUND

Instant messaging is a means of sending and receiving messages instantly. With the development of mobile Internet, instant messaging is not only a chat tool, but also a comprehensive information platform integrating communication, news, entertainment, search, e-commerce, office collaboration, enterprise customer service, and so on.

Conventionally, instant messages are displayed in a dialogue window according to a time sequence of the instant messages. When related instant messages distribute at different times, however, a user may have difficulty in browsing and looking up them efficiently.

### SUMMARY

According to a first aspect of the present disclosure, there is provided a method for a terminal to manage an instant message, comprising: determining whether the instant message is a reply to an existing message when receiving or sending the instant message; if the instant message is not a reply to any existing message, creating a new session and adding the instant message as a root node into the new session; and if the instant message is a reply to an existing message, adding the instant message into a session to which the existing message belongs and setting the instant message as a child node of the existing method.

According to a second aspect of the present disclosure, there is provided a device for managing an instant message, comprising: a processor; and a memory for storing instructions executable by the processor; wherein the processor is configured to: determine whether the instant message is a reply to an existing message when receiving or sending the instant message; if the instant message is not a reply to any existing message, create a new session and add the instant message as a root node into the new session; and if the instant message is a reply to an existing message, add the instant message into a session to which the existing message belongs and set the instant message as a child node of the existing message.

According to a third aspect of the present disclosure, there is provided a non-transitory computer-readable storage medium storing instructions that, when executed by a processor of an electronic device, cause the electronic device to perform a method for managing an instant message, the method comprising: determining whether the instant message is a reply to an existing message when receiving or sending the instant message; if the instant message is not a reply to any existing message, creating a new session and adding the instant message as a root node into the new session; and if the instant message is a reply to an existing message, adding the instant message into a session to which the existing message belongs and setting the instant message as a child node of the existing message.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flowchart of a method for managing an instant message, according to an exemplary embodiment.

FIG. 2 is a flowchart of a method for managing an instant message, according to an exemplary embodiment.

FIG. 3 is a flowchart of a method for managing an instant message, according to an exemplary embodiment.

FIG. 4 is a block diagram of a device for managing an instant message, according to an exemplary embodiment.

FIG. 5 is a block diagram of a device for managing an instant message, according to an exemplary embodiment.

FIG. 6 is a block diagram of a device for managing an instant message, according to an exemplary embodiment.

FIG. 7 is a block diagram of a device for managing an instant message, according to an exemplary embodiment.

FIG. 8 is a block diagram of a device for managing an instant message, according to an exemplary embodiment.

### DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with aspects associated to the invention as recited in the appended claims.

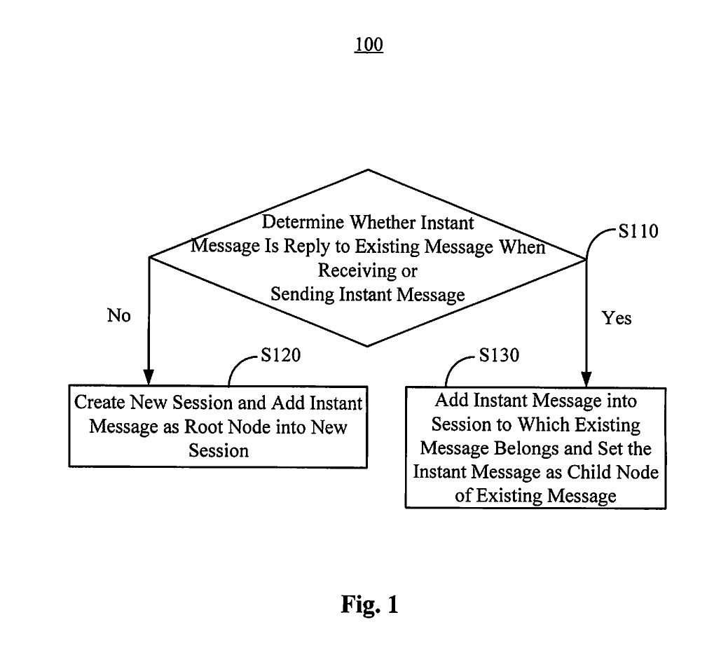

FIG. 1 is a flowchart of a method 100 for managing an instant message, according to an exemplary embodiment. For example, the method 100 may be used in a terminal. Referring to FIG. 1, the method 100 includes the following steps.

In step S110, the terminal determines whether an instant message is a reply to an existing message when receiving or sending the instant message. If the instant message is not a reply to any existing message, step S120 is performed; otherwise, step S130 is performed.

In exemplary embodiments, the instant message may be an instant message sent by the terminal or received by the terminal from another terminal. Moreover, the instant message may be a message in a two-user dialogue or a multi-user dialogue. The present disclosure does not make specific limitation on these aspects.

In step S120, the terminal creates a new session, and adds the instant message as a root node into the new session.

In the present embodiment, a session is a set of instant messages, which includes at least one and generally multiple instant messages. Expect for a first instant message, all other instant messages in a session are replies. Therefore, the instant messages in a session are related, and may be considered the instant messages regarding a same theme. For example, a session regarding the theme “birthday” in a two-user dialogue between terminal A and terminal B may contain 20 instant messages. Also for example, in a multi-user dialogue among terminal A, terminal C, and terminal D, a session regarding the theme “festival” may contain 30 instant messages; a session regarding the theme “ticket” may contain 50 instant messages; and so on.

In exemplary embodiments, when a session is created, various kinds of information related to the session, such as a theme name and a timestamp of the session, may be generated. The theme name may be generated using a default name or the content input by a user. For example, the default theme name may be partial or whole content of the first instant message in the session. Also for example, the user may be provided with an edit function to input a desired theme name in an edit box. The timestamp of the session may be generated using the timestamp of the first instant message, and the present disclosure does not make specific limitation on this aspect.

In step S130, the terminal adds the instant message into a session to which the existing message belongs, and sets the instant message as a child node of the existing message.

In exemplary embodiments, storing the instant message according to the method 100 generates at least one session of tree structure, with each session having its own theme. The terminal may obtain a plurality of sessions and establish a session list to store the sessions. The terminal may display the sessions in a session list. To facilitate the user's viewing, the sessions in the session list may be arranged according to their respective timestamps. The displayed sessions contain, e.g., at least their theme names. The instant messages in the session may be also displayed. Optionally, the instant messages may be displayed in a tree structure, in a thumbnail that will unfold into the tree structure after being clicked by the user, or in any other ways. The present embodiment does not make specific limitation on this aspect.

The method 100 may be applied in a two-user dialogue or a multi-user dialogue. When the terminal participates in a multi-user dialog discussing multiple themes, the method 100 may form the hierarchy of logical relevancy according to the themes and obtain a session of tree structure for each theme, which makes it convenient for the user to browse and look up the instant messages. Compared with arranging instant messages according to a time sequence of the instant messages, the method 100 saves time for browsing and looking up instant messages, improves the efficiency, and is convenient to use.

In one exemplary embodiment, creating the new session and adding the instant message as the root node into the new session may include: creating the new session and adding the instant message to the new session; and setting an associated attribute of the instant message to be null or the root node of the new session.

In one exemplary embodiment, adding the instant message into the session to which the existing message belongs and setting the instant message as the child node of the existing message may include: adding the instant message into the session to which the existing message belongs; and setting the associated attribute of the instant message as a child node of the existing message.

In one exemplary embodiment, the method 100 may further include: detecting a designated operation on an instant message in an existing session; and creating a new session to set the instant message as a root node, and adding the instant message and its child node(s) into the new session.

In one exemplary embodiment, the method 100 may further include: detecting a designated operation on an instant message in an existing session; and deleting the instant message and its child nodes from the existing session.

The method 100 organizes related instant messages in at least one session of tree structure, which provides a new instant-message storage mode, and enables the user to quickly browse and look up an instant message according to the parent-child relationship between the nodes. Thus, the method 100 improves the efficiency of browsing and looking up instant messages and is convenient to use.

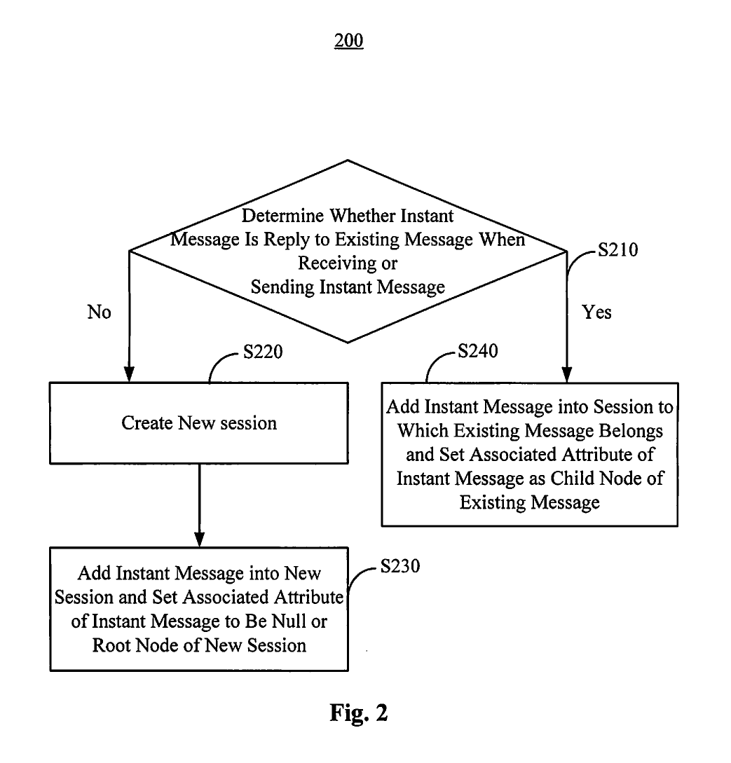

FIG. 2 is a flowchart of a method 200 for managing an instant message, according to an exemplary embodiment. For example, the method 200 may be used in a terminal. Referring to FIG. 2, the method 200 includes the following steps.

In step S210, the terminal determines whether an instant message is a reply to an existing message when receiving or sending the instant message. If the instant message is not a reply to any existing message, step S220 is performed; otherwise, step S240 is performed.

In step S220, the terminal creates a new session for the instant message. A theme name may be generated for the session using a default name or the content input by the user. Other information, such as the session's identification (ID) and timestamp, may also be generated.

In step S230, the terminal adds the instant message into the session, sets an associated attribute of the instant message to be null or a root node of the session.

For example, the root node is a first node in the session and is a top of a tree structure. Typically, there is one root node in a tree structure. The root node may have a plurality of child nodes, and is their parent node. Each child node may also have its own child node. As for two instant messages A and B, if instant message B is a reply to instant message A, then instant message A corresponds to the parent node and instant message B corresponds to the child node.

Generally, an instant message has multiple kinds of associated information, such as an ID, a timestamp, and content of the instant message. In the present embodiment, the associated information may further include: the ID of the session to which the instant message belongs, an associated attribute of the instant message, and so on. The associated attribute is used to set the relevance of the instant message to other instant messages. For example, the associated attribute of the instant message may be set to be null or the ID of the instant message to represent that the instant message corresponds to the root node of the session, or may be set as the ID of a parent node to represent that the instant message corresponds to a child node of the parent node.

In step S240, the terminal adds the instant message into the session to which the existing message belongs, and sets the associated attribute of the instant message as a child node of the existing message.

In one exemplary embodiment, setting the associated attribute of the instant message as a child node of the existing message may include: setting the associated attribute of the instant message as the ID of the existing message to represent that the existing message corresponds to the parent node of the current instant message and the current instant message corresponds to a child node of the existing message. This way, the relevance of the existing instant message and the current instant message can be established.

In one exemplary embodiment, the method 200 may further include: detecting a designated operation on an instant message in an existing session; and creating a new session to set the instant message as the root node, and adding the instant message and its child node(s) into the new session.

In one exemplary embodiment, the method 200 may further include: deleting the instant message and its child node(s) from the session after detecting the designated operation.

The method 200 organizes related instant messages in a session of tree structure, which provides a new instant-message storage mode, and enables the user to browse and look up instant messages quickly according to the parent-child relationship between the nodes. Thus, the method 200 improves the efficiency of browsing and looking up the instant messages and is convenient to use.

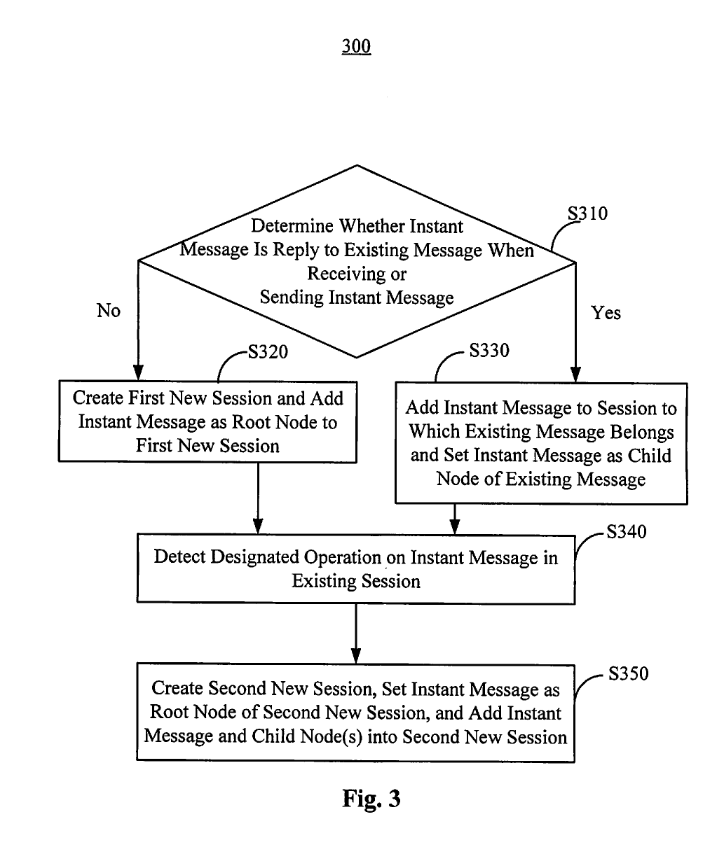

FIG. 3 is a flowchart of a method 300 for managing an instant message, according to an exemplary embodiment. For example, the method 300 may be used in a terminal. Referring to FIG. 3, the method 300 includes the following steps.

In step S310, the terminal determines whether the instant message is a reply to an existing message when receiving or sending the instant message. If the instant message is not a reply to any existing message, step S320 is performed; otherwise, step S330 is performed.

In step S320, the terminal creates a first new session, and adds the instant message as a root node into the first new session. In one exemplary embodiment, creating the first new session and adding the instant message as the root node into the first new session may include: creating the first new session and add the instant message into the first new session; and setting an associated attribute of the instant message to be null or the root node of the first new session.

In step S330, the terminal adds the instant message into the session to which the existing message belongs, and sets the instant message as a child node of the existing message. In one exemplary embodiment, adding the instant message into the session to which the existing message belongs and setting the instant message as a child node of the existing message may include: adding the instant message to the session to which the existing message belongs; and setting the associated attribute of the instant message as a child node of the existing message.

In step S340, the terminal detects a designated operation on an instant message in an existing session. In the present embodiment, the designated operation may be set up according to user need, and may be any operation, such as a long-press operation, a single-click operation, a double-click operation, a drag operation, and so on. The existing session may be the first new session created in step S320 or the session to which the existing message belongs in step S330.

In step S350, the terminal create a second new session, sets the instant message receiving the designated operation as the root node of the second new session, and adds the instant message and its child node(s) into the second new session.

In exemplary embodiments, the child node(s) of the instant message include all of the child nodes of the instant message. Adding the instant message and its child node(s) into the second new session may include: setting the instant message as the root node of the second new session by setting the associated attribute of the instant message to be null or its own ID; and keeping the associated attribute of each of the remaining child nodes unchanged, to retain the parent-child relationship in the original session.

After the second new session is created, if there is already a session list, then the second new session is added to the session list. The sessions are rearranged according to their respective timestamps, to facilitate the user's browsing and looking up the instant messages. The theme name of the second new session may also be generated, similar to the above description.

In one exemplary embodiment, after detecting the designated operation on the instant message in the existing session, the method 300 may further include: deleting the instant message and its child node(s) from the existing session.

In exemplary embodiments, the deleting may be the operation of deleting the associated attribute, not content, of the instant message. It may be achieved in the following way: deleting the associated attribute of each of the instant message and its child node(s), so that these nodes no longer belong to the existing session or have any parent-child relationship. The user may look up these instant messages according to their respective timestamps.

In the present embodiment, the deletion of the instant message and its child node(s) is optional. With the deletion, the instant message and its child node(s) no longer exist in the original session. Without the deletion, the instant message and its child node(s) remain in the original session, which corresponds to a duplicate copy to the second new session.

For example, the tree structure of session 1 is: the root node A, A's child nodes B and C, B's child nodes D and E, and C's child node F. Each of nodes A through F corresponds to an instant message in session 1. After detecting a long-press operation on the instant message corresponding to child node B, the terminal creates session 2, and adds the instant messages corresponding to child node B and its child nodes D and E into session 2, in order to move a part of session 1 to the newly created session 2. In session 2, B is the root node, and D and E are its child nodes. The instant messages corresponding to child nodes B, D, and E may be either deleted from or retained in session 1.

The existing sessions may be conveniently managed in this way. If an existing session has contents related to a plurality of themes, a part of the contents corresponding to each theme can be separated out and managed as one session.

In one exemplary embodiment, after creating the second new session, the method 300 may further include: generating a theme name for the second new session using a default name or a content input by the user.

The method 300 organizes related instant messages in a session of tree structure, which provides a new instant-message storage mode, and enables the user to quickly browse and look up instant messages according to the parent-child relationship between the nodes. Thus, the method 300 improves the efficiency of browsing and looking up the instant messages and is convenient to use. In addition, by separating out a part of an existing session to form a new session, the method 300 is capable of managing and maintaining an existing session. Because the method 300 achieves the effect of adjusting the tree structure of a session, it makes the session-based management of instant messages fast and convenient.

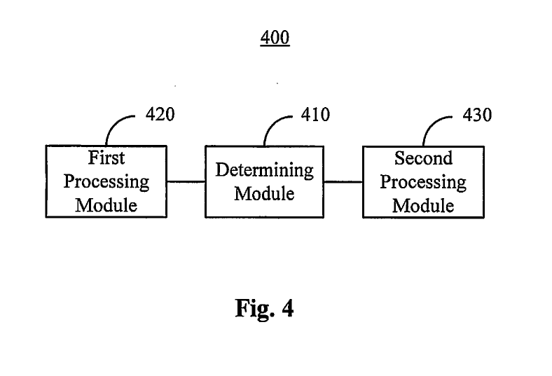

FIG. 4 is a block diagram of a device 400 for managing an instant message, according to an exemplary embodiment. Referring to FIG. 4, the device 400 includes a determining module 410, a first processing module 420, and a second processing module 430.

The determining module 410 is configured to determine whether an instant message is a reply to an existing message at the time of receiving or sending the instant message.

The first processing module 420 is configured to create a new session and add the instant message as a root node into the new session when the instant message is not a reply to any existing message.

The second processing module 430 is configured to add the instant message into a session to which the existing message belongs and set the instant message as a child node of the existing message when the instant message is a reply to an existing message.

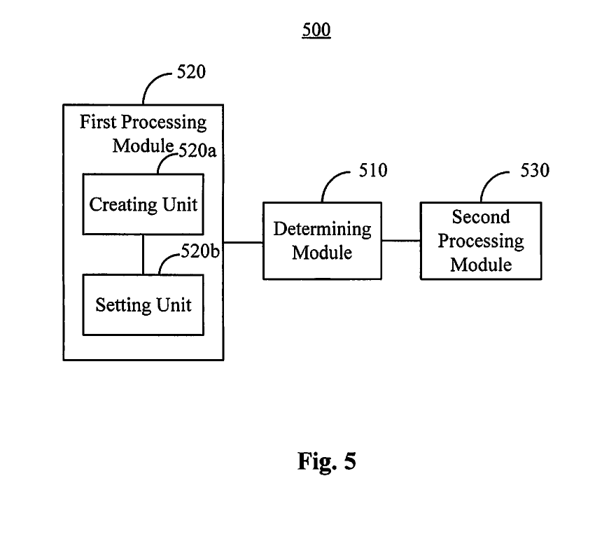

FIG. 5 is a block diagram of a device 500 for managing an instant message, according to an exemplary embodiment. Referring to FIG. 5, the device 500 includes a determining module 510, a first processing module 520, and a second processing module 530, similar to the determining module 410, the first processing module 420, and the second processing module 430 (FIG. 4), respectively.

In exemplary embodiments, the first processing module 520 may include a creating unit 520a and a setting unit 520b. The creating unit 520a is configured to create a new session and add an instant message to the new session when the instant message is not a reply to any existing message. The setting unit 520b is configured to set an associated attribute of the instant message to be null or the root node of the new session.

In exemplary embodiments, the second processing module 530 may include an adding unit and a setting unit (not shown). The adding unit is configured to add the instant message into the session to which the existing message belongs when the instant message is a reply to an existing message. The setting unit is configured to set the associated attribute of the instant message as a child node of the existing message.

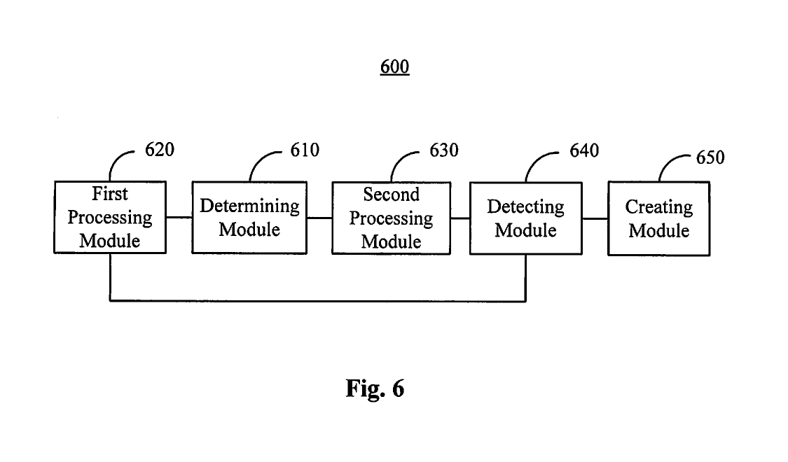

FIG. 6 is a block diagram of a device 600 for managing an instant message, according to an exemplary embodiment. Referring to FIG. 6, the device 600 may further include a detecting module 640 and a creating module 650, in addition to a determining module 610, a first processing module 620 and a second processing module 630, which are similar to the determining module 410, the first processing module 420, and the second processing module 430 (FIG. 4), respectively.

In exemplary embodiments, the detecting module 640 is configured to detect a designated operation on an instant message in an existing session. The creating module 650 is configured to create a new session, set the instant message as the root node of the new session, and add the instant message and its child node(s) to the new session, when the detecting module 640 detects the designated operation.

In exemplary embodiments, the device 600 may further include a deleting module (not shown). The deleting module is configured to delete the instant message and its child node(s) from the existing session after the detecting module 640 detects the designated operation.

In exemplary embodiments, the device 600 may further include a setting module (not shown) configured to generate a theme name for the new session using a default name or the content input by the user after the first processing module 620 creates the new session.

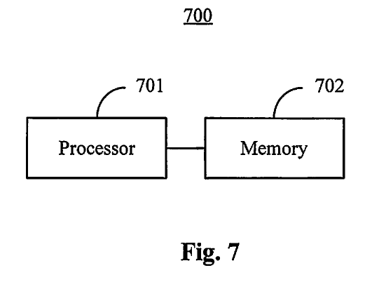

FIG. 7 is a block diagram of a device 700 for managing an instant message, according to an exemplary embodiment. The device 700 includes, e.g., a processor 701 and a memory 702 for storing instructions executable by the processor. The processor is configured to execute the instructions for performing the methods 100 (FIG. 1), 200 (FIGS. 2), and 300 (FIG. 300).

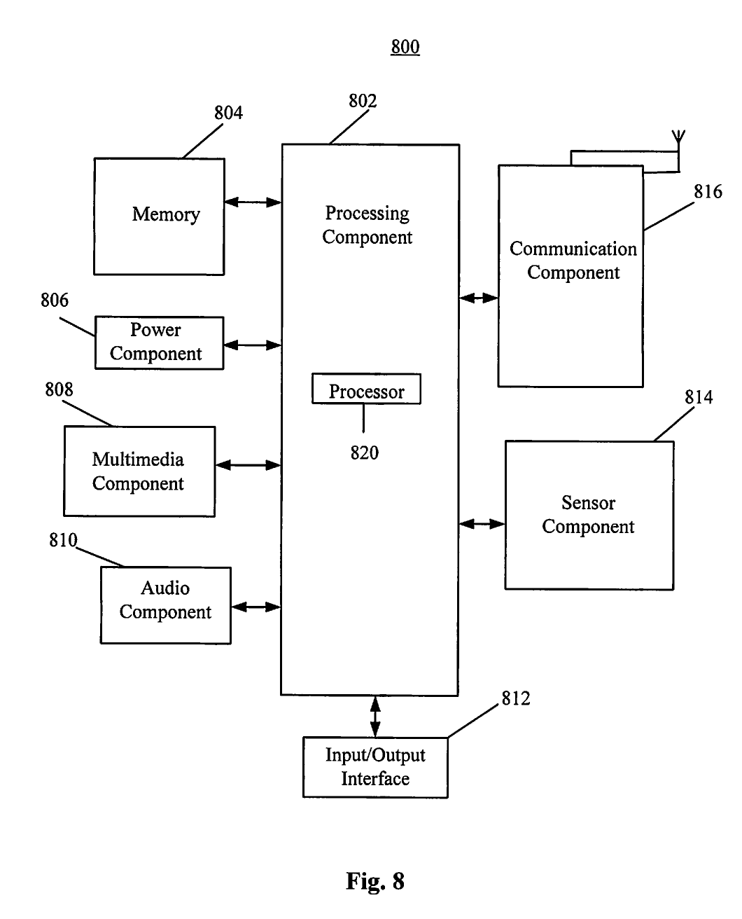

FIG. 8 is a block diagram of a device 800 for managing an instant message, according to an exemplary embodiment. For example, the device 800 may be a mobile phone, a computer, a digital broadcast terminal, a messaging device, a gaming console, a tablet, a medical device, exercise equipment, a personal digital assistant, and the like.

Referring to FIG. 8, the device 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls overall operations of the device 800, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the device 800. Examples of such data include instructions for any applications or methods operated on the device 800, contact data, phonebook data, messages, pictures, videos, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the device 800. The power component 806 may include a power management system, one or more power sources, and any other components associated with the generation, management, and distribution of power in the device 800.

The multimedia component 808 includes a screen providing an output interface between the device 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, slides, and gestures on the touch panel. The touch sensors may not only sense a boundary of a touch or slide action, but also sense a period of time and a pressure associated with the touch or slide action. In some embodiments, the multimedia component 808 includes a front camera and/or a rear camera. The front camera and/or the rear camera may receive an external multimedia datum while the device 800 is in an operation mode, such as a photographing mode or a video mode. Each of the front camera and the rear camera may be a fixed optical lens system or may have focus and optical zoom capability.

The audio component 810 is configured to output and/or input audio signals. For example, the audio component 810 includes a microphone configured to receive an external audio signal when the device 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide status assessments of various aspects of the device 800. For instance, the sensor component 814 may detect open/closed statuses of the device 800, and relative positioning of components, such as the display and the keypad. The sensor component 814 may also detect position changes of the device 800 or its components, presence or absence of user contacts with the device 800, orientation or acceleration/deceleration of the device 800, and temperature changes of the device 800. The sensor component 814 may further include a proximity sensor configured to detect the presence of nearby objects without any physical contact. Moreover, the sensor component 814 may include a light sensor, such as a CMOS or CCD image sensor, for use in imaging applications. In some embodiments, the sensor component 814 may also include an acceleration sensor, a gyroscope sensor, a magnetic sensor, a pressure sensor, or a temperature sensor.

The communication component 816 is configured to facilitate wired or wireless communications between the device 800 and other devices. The device 800 can access a wireless network based on a communication standard, such as WiFi, 2G, 3G, or a combination thereof. In one exemplary embodiment, the communication component 816 receives a broadcast signal or broadcast related information from an external broadcast management system via a broadcast channel. In another exemplary embodiment, the communication component 816 further includes a near-field communication (NFC) module to facilitate short-range communications. The NFC module, for example, may be implemented based on a radio frequency identification (RFID) technology, an infrared data association (IrDA) technology, an ultra-wideband (UWB) technology, a Bluetooth (BT) technology, and other technologies.

In the exemplary embodiments, the device 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components.

In the exemplary embodiments, there is also provided a non-transitory computer-readable storage medium including instructions, such as included in the memory 804, executable by the processor 820 in the device 800, for performing the above-described methods. For example, the non-transitory computer-readable storage medium may be a ROM, a random access memory (RAM), a CD-ROM, a magnetic tape, a floppy disc, an optical data storage device, and the like.

One of ordinary skill in the art will understand that the above described modules/units can each be implemented by hardware, or software, or a combination of hardware and software. One of ordinary skill in the art will also understand that multiple ones of the above described modules/units may be combined as one module/unit, and each of the above described modules/units may be further divided into a plurality of sub-modules/sub-units.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for a terminal to manage an instant message, comprising:
determining whether the instant message is a reply to an existing message when receiving or sending the instant message;
if the instant message is not a reply to any existing message, creating a new session and adding the instant message as a root node into the new session; and
if the instant message is a reply to an existing message, adding the instant message into a session to which the existing message belongs and setting the instant message as a child node of the existing message.

2. The method according to claim 1, wherein the creating of the new session and adding of the instant message as the root node into the new session comprise:
creating the new session and adding the instant message into the new session; and
setting an associated attribute of the instant message to be null or the root node of the new session.

3. The method according to claim 1, wherein the adding of the instant message into the session to which the existing message belongs and the setting of the instant message as the child node of the existing message comprise:
adding the instant message into the session to which the existing message belongs; and
setting an associated attribute of the instant message as a child node of the existing message.

4. The method according to claim 1, wherein the new session is a first new session, the method further comprising:
detecting a designated operation on an instant message in an existing session; and
creating a second new session, setting the instant message receiving the designated operation as a root node of the second new session, and adding the instant message receiving the designated operation and one or more child nodes thereof into the second new session.

5. The method according to claim 4, further comprising:
deleting the instant message and the one or more child nodes from the existing session after detecting the designated operation.

6. The method according to claim 1, wherein the creating of the new session further comprises:
after the new session is created, generating a theme name for the new session using a default name or a content input by a user.

7. A device for managing an instant message, comprising:
a processor; and
a memory for storing instructions executable by the processor;
wherein the processor is configured to:
determine whether the instant message is a reply to an existing message when receiving or sending the instant message;
if the instant message is not a reply to any existing message, create a new session and add the instant message as a root node into the new session; and
if the instant message is a reply to an existing message, add the instant message into a session to which the existing message belongs and set the instant message as a child node of the existing message.

8. The device according to claim 7, wherein the processor is further configured to:
if the instant message is not a reply to any existing message, set an associated attribute of the instant message to be null or the root node of the new session.

9. The device according to claim 7, wherein the processor is further configured to:
if the instant message is a reply to an existing message, set an associated attribute of the instant message as a child node of the existing message.

10. The device according to claim 7, wherein the new session is a first new session, the processor is further configured to:
detect a designated operation on an instant message in an existing session; and
create a second new session, set the instant message receiving the designated operation as a root node of the second new session, and add the instant message receiving the designated operation and one or more child nodes thereof into the new session.

11. The device according to claim 10, wherein the processor is further configured to:
delete the instant message and the one or more child nodes from the existing session after detecting the designated operation.

12. The device according to claim 7, wherein the processor is further configured to:
generate a theme name for the new session using a default name or a content input by a user, after the new session is created.

13. A non-transitory computer-readable storage medium storing instructions that, when executed by a processor of an electronic device, cause the electronic device to perform a method for managing an instant message, the method comprising:
determining whether the instant message is a reply to an existing message when receiving or sending the instant message;
if the instant message is not a reply to any existing message, creating a new session and adding the instant message as a root node into the new session; and
if the instant message is a reply to an existing message, adding the instant message into a session to which the existing message belongs and setting the instant message as a child node of the existing message.

14. The medium according to claim 13, wherein the creating of the new session and adding of the instant message as the root node into the new session comprise:
creating the new session and adding the instant message into the new session; and
setting an associated attribute of the instant message to be null or the root node of the new session.

15. The medium according to claim 13, wherein the adding of the instant message into the session to which the existing message belongs and the setting of the instant message as the child node of the existing message comprise:
adding the instant message into the session to which the existing message belongs; and
setting an associated attribute of the instant message as a child node of the existing message.

16. The medium according to claim 13, wherein the new session is a first new session, the method further comprising:
detecting a designated operation on an instant message in an existing session; and
creating a second new session, setting the instant message receiving the designated operation as a root node of the second new session, and adding the instant message receiving the designated operation and one or more child nodes thereof into the new session.

17. The medium according to claim 16, wherein the method further comprises:
deleting the instant message and the one or more child nodes from the existing session after detecting the designated operation.

18. The medium according to claim 13, wherein the creating of the new session further comprises:
after the new session is created, generating a theme name for the new session using a default name or a content input by a user.
